(19) United States
(12) Patent Application Publication
(10) Pub. No.: US 2010/0041794 A1
(43) Pub. Date: Feb. 18, 2010

(54) HYDROXYL-TERMINATED OR CARBOXYLIC ACID-TERMINATED REACTIVE MONOMER COMPOSITIONS, THEIR PREPARATION AND THEIR USE

(76) Inventors: Jim D. Earls, Lake Jackson, TX (US); Jerry E. White, Lake Jackson, TX (US); Fabio Aguirre Vargas, Lake Jackson, TX (US); Zenon Lysenko, Midland, MI (US); Maurice J. Marks, Lake Jackson, TX (US)

Correspondence Address: The Dow Chemical Company, Intellectual Property Section, P.O. Box 1967, Midland, MI, 48641-1967, US

(21) Appl. No.: 12/522,638

(22) PCT Filed: Dec. 11, 2007
(86) PCT No.: PCT/US07/87054

§ 371 Date: Jul. 9, 2009

Related U.S. Application Data
(60) Provisional application No. 60/880,332, filed on Jan. 12, 2007.
(60) Provisional application No. 60/920,599, filed on Mar. 29, 2007.

(51) Int. Cl. C09D 7/12; C08G 69/00; C08L 63/00

(52) U.S. Cl. 523/400; 528/363; 525/450

(57) ABSTRACT

The present invention relates to new reactive monomer compositions that have a plurality of reactive, functional moieties, such as one or both of a hydroxyl moiety or a carboxylic acid moiety. The present invention also further relates to use of such reactive monomer compositions as a component of curable coating compositions, especially curable powder coating compositions.

This application claims the benefit of U.S. Provisional Application Nos. 60/880,332 filed Jan. 12, 2007 and 60/920,599 filed Mar. 29, 2007.

The present invention relates generally to novel reactive monomer compositions that have a plurality of reactive, functional moieties, such as one or both of a hydroxyl moiety or a carboxylic acid moiety. The present invention relates particularly to reactive monomer compositions that have at least (≧) one terminal (proximate to a monomer end) reactive moiety and, optionally, from one to as many as three internal (spaced away from a monomer end) reactive moiety(ies). The reactive monomer compositions may comprise mixtures of ≧seventy percent by weight (70 wt %), based upon total reactive monomer composition weight, of a reactive monomer with at least one terminal reactive moiety and at least one internal reactive moiety and up to (≦) 30 wt %, based upon total reactive monomer composition weight, of a reactive monomer that has ≧ one terminal reactive moiety and no internal reactive moiety. The present invention also relates to processes used to prepare the reactive monomer compositions, especially reactive monomer compositions derived from renewable raw material sources such as unsaturated seed or vegetable oils, either naturally occurring oils or oils from genetically-modified plants. The present invention further relates to use of such reactive monomer compositions as a component of curable coating compositions, especially curable powder coating compositions.

U.S. Pat. No. 5,744,531 and its Patent Cooperation Treaty Application counterpart, WO 97/49772 (collectively Kerr et al.) disclose anionic electrocoating compositions that contain ≧ one of a specific class of beta (β)-hydroxyalkylamide curing agents plus an electrodepositable polymer capable of cross-linking with the curing agent. The curing agent includes an organic radical that a) contains from 8 to 60 carbon atoms (C₈-C₆₀), b) is derived from a substituted or unsubstituted aliphatic, alicyclic or aromatic hydrocarbon radical, and c) is bonded to n β-hydroxyalkylamide groups, n being an integer from 1 to 4.

U.S. Pat. No. 5,216,090 (Merritt et al.) teaches a thermosetting powder composition that comprises a reactable mixture of a carboxylic acid group-containing polyester or acrylic, a fatty acid hydroxyalkylamide group-containing material and a β-hydroxyalkylamide curing agent.

U.S. Pat. No. 4,101,606 (Cenci et al.) discusses β-hydroxyalkylamide polymers as curing agents for polymers that contain one or more carboxy or anhydride functions.

European Patent (EP) 0 698 645 (Hoppe et al.) claims a process for preparing heat-curable, epoxide-free coating powders by co-extruding a carboxyl-terminated polyester and a β-hydroxyalkylamide with at least two β-hydroxyalkylamide groups per molecule and/or mixtures of difunctional and polyfunctional β-hydroxyalkylamides.

WO 94/03545 (Stanssens et al.) discusses powder coating compositions with a hydroxyalkylamide crosslinker. The crosslinker comprises a combination of at least two compounds that contain β-hydroxyalkylamide groups, each compound having a different β-hydroxyalkylamide functionality.

EP 0 471 409 (Schippers et al.) relates to powder coating compositions that comprise a polymer with one or more free carboxylic acid groups and a compound containing one or more β-hydroxyalkylamide groups.

A continuing need exists for improvements in coating formulations or compositions. Desired improvements lie in one or more of environmental acceptance, e.g. very low and preferably no toxicity, cost, renewable resource options, and physical property performance (e.g. coating flexibility, toughness, adhesion, hardness, moisture resistance or chemical resistance).

U.S. Pat. No. 6,245,829 (Meij et al.) discusses radiation-curable compositions comprising a mono- or multi-valent carboxylic ester of a β-hydroxyalkylamide group containing compound, in which the carboxylic ester is derived from an α,β-ethylenically unsaturated carboxylic acid.

As used throughout this specification, definitions presented in this paragraph, in succeeding paragraphs or elsewhere in the specification, have meanings ascribed to them where first defined. Accordingly, “hydrocarbyl” means a monovalent straight or branched chain, saturated or unsaturated predominantly hydrocarbon moiety having from one to 60 carbon atoms (C₁-C₆₀). “Hydrocarbylene” means a polyvalent straight or branched chain, saturated or unsaturated predominantly hydrocarbon moiety having one to 60 carbon atoms (C₁-C₆₀).

“Fatty acid” means a predominantly aliphatic acid with more than (>) 8 carbons.

“Fatty acid ester” means a predominantly aliphatic ester with more than 8 carbons.

When ranges are stated herein, as in a range of from 2 to 10, both end points of the range (e.g. 2 and 10) are included within the range unless otherwise specifically excluded.

A first aspect of the present invention is a hydroxyl terminated monmer composition comprising a hydroxyl terminated monomer represented by Formula I.

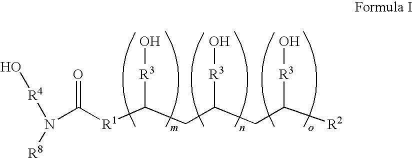

In Formula I, R¹ is a hydrocarbylene moiety; R² is hydrogen or a hydrocarbyl moiety; R³ is nil or a hydrocarbylene moiety; R⁴ is a hydrocarbylene moiety; R⁸ is hydrogen (II), a hydrocarbyl moiety, or a moiety represented by Formula II:

—R⁴—OH Formula II

wherein R⁴ is as defined above; and m, n, and o are independently 0 or 1 provided a sum of m, n and o is greater than zero in admixture with an amount of a second hydroxyl terminated monomer represented by Formula I wherein the sum of m, n and o is zero.

A second aspect is a curable composition, the composition comprising the hydroxyl terminated monomer composition of the first aspect, a carboxylic acid terminated monomer and, optionally, either or both of a hydroxyalkylamide other than the hydroxyl terminated monomer of the first aspect or the hydroxyl terminated monomer composition of the second aspect, and a multi-functional epoxy resin.

A third aspect comprises a reactive monomer composition, the composition comprising an amide carboxylic acid represented by Formula III:

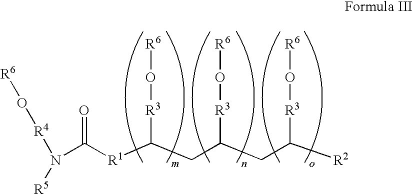

wherein R¹ is a hydrocarbylene moiety; R² is hydrogen or a hydrocarbyl moiety; R³ is nil or a hydrocarbylene moiety; R⁴ is a hydrocarbylene moiety; R⁵ is H, a hydrocarbyl moiety or a moiety represented by Formula IV:

—R⁴—O—R⁶ Formula IV

wherein R⁴ is as defined above and R⁶ is a moiety of Formula V:

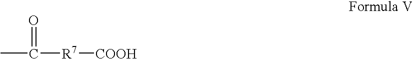

wherein R⁷ is a hydrocarbylene moiety; and m, n, and o are independently 0 or 1 provided a sum of m, n and o is greater than zero.

A fourth aspect comprises a curable resin composition, the curable resin composition comprising the reactive monomer composition of the third fourth aspect, a multi-functional epoxy resin and, optionally, either or both of a monomer having a terminal carboxylic acid moiety, the monomer being a monomer other than the reactive monomer composition, and a curing catalyst.

A fifth aspect is a process for preparing a reactive monomer with a terminal carboxylic acid moiety, the process comprising reacting a carboxylic acid anhydride with at least one of:

a. a ring opened epoxidized oil represented by Formula VI

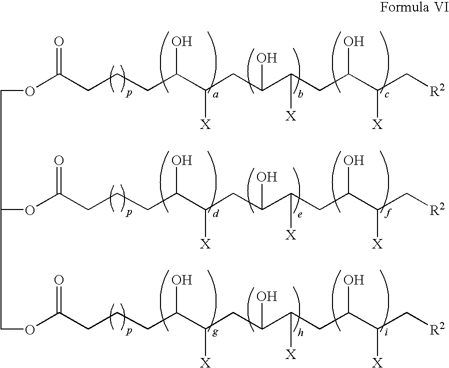

b. a ring opened epoxidized fatty acid ester or a ring opened epoxidized fatty acid represented by Formula VII

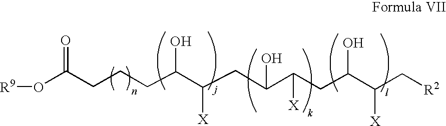

wherein R² is hydrogen or a hydrocarbyl moiety; R⁹ is hydrogen or a hydrocarbyl moiety; n and p are 0 or a positive integer within a range of from 1-20; a, b, c, d, e, f, g, h, i, j, k and l are independently 0 or 1, provided that a sum of a, b, c, d, e, f, g, h and i or a sum of j, k and l is greater than zero; and X is:

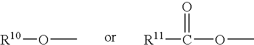

wherein R¹⁰ is independently hydrogen, a hydroxyl hydrocarbyl moiety or a hydrocarbyl moiety; and R¹¹ is independently hydrogen or a hydrocarbyl moiety; or

c. a product of an alcoholysis reaction between castor oil and a polyol.

An aspect related to the fifth aspect comprises a reactive monomer prepared by the process of the fifth aspect.

A sixth aspect is a curable composition comprising such a reactive monomer, a multi-functional epoxy resin, and, optionally, either or both of a monomer having a terminal carboxylic acid moiety, said monomer differing from the reactive monomer produced by the process of the sixth aspect, and a curing catalyst.

A seventh aspect is a coating composition, the coating composition comprising the curable composition of any of the second, fourth or sixth aspect or the reactive monomer composition of the third aspect or the reactive monomer prepared by the fifth aspect. Powder coatings based upon such compositions find utility in a variety of applications including coating of architectural aluminum, coating of household or office furniture and hardware used for such furniture, coating of building products such as soffits, fascia, siding, door and window frames, and plumbing fixtures, coating of electrical equipment such as transformers or generators, coating of machine tools or pallet racks, coating of appliances such as washers, dryers, water heaters, swamp coolers and furnaces, coating of automotive parts, especially under the hood parts and interior brackets and flanges, as well as oil filters and use as a primer surfacer/antichip coating for vehicle bodies, and coatings for general metal applications such as boxes, toys, stampings, frames, home gym sets, and exercise equipment.

Illustrative examples of hydroxyl terminated monomers represented by Formula I include N,N-(2-hydroxyethyl) 12-hydroxystearmaide; N,N-(2-hydroxyethyl) 12-hydroxymethylstearamide, N,N-(2-hydroxyethyl) 9,12-hydroxymethylstearamide; N,N-(2-hydroxyethyl) 9,12,15-hydroxymethylstearamide and 11-hydroxyundecanoamide.

The hydroxyl terminated monomer composition of the first second aspect is a mixture of at least two different monomers represented by Formula I above. One monomer has a sum of m, n and o greater than zero and the other has a sum of m, n and o equal to zero. An illustrative example of the monomer having a sum of m, n and o equal to zero is N,N-(2-hydroxyethyl)stearamide. The hydroxyl terminated monomer composition preferably contains ≧70 wt %, more preferably ≧75 wt % and still more preferably ≧90 wt %, in each case based upon total composition weight, of the monomer having a sum of m, n and o greater than (>) zero.

Curable compositions of the second aspect include the monomer composition of the first aspect in admixture with a carboxylic acid terminated monomer. The curable composition optionally includes either or both of two additional components. One additional component is a hydroxylamide that differs from any component of the monomer composition of the first aspect. When present, this hydroxylamide is present in an amount of from 5 wt % to 95 wt %, preferably from 25 wt % to 75 wt %, more preferably from 25 wt % to 50 wt %, in each case based upon equivalent weight of carboxylic acid (COOH) present in the carboxylic acid terminated monomer. A second additional component is a multi-functional epoxy resin. When present, the multi-functional epoxy resin is present in an amount of from 5 wt % to 95 wt %, preferably from 25 wt % to 75 wt %, more preferably from 25 wt % to 50 wt %, in each case based upon equivalent weight of carboxylic acid (COOH) present in the carboxylic acid terminated monomer. The carboxylic acid terminated monomer functions as a primary curable component of the curable compositions.

Suitable carboxylic acid terminated monomers include those obtained by reacting the hydroxyterminated monomers of the first aspect of this invention with anhydrides such as maleic anhydride, succinic anhydride, phthalic anhydride, cis-1,2,3,6-tetrahydrophthalic anhydride, 1,2,4,5 benzene tetracarboxylic dianhydride and trimellitic anhydride. More preferred carboxylic acid terminated monomers include those based on succinic anhydride, cis-1,2,3,6-tetrahydrophthalic anhydride, phthalic anhydride and 1,2,4,5 benzene tetracarboxylic dianhydride. The carboxylic acid terminated monomer which is most preferred is one based on a combination of phthalic anhydride and 1,2,4,5 benzene tetracarboxylic dianhydride.

Satisfactory results follow when the hydroxylamide additional component is selected from N,N,N′,N′Tetrakis (2-hydroxyethyl)cyclohexanamide, N,N,N′,N′Tetrakis (2-hydroxyethyl)adipamide and N,N,N′,N′Tetrakis (2-hydroxyethyl)succinamide. The hydroxylamide is preferably selected from N,N,N′,N′Tetrakis (2-hydroxyethyl)adipamide and N,N,N′,N′Tetrakis (2-hydroxyethyl)succinamide, most preferably N,N,N′,N′Tetrakis (2-hydroxyethyl)adipamide.

The epoxy resin is preferably selected from a multi-functional bisphenol glycidyl ether having an epoxide equivalent weight of from 150 to 4000. The epoxy resin is more preferably selected from a multi-functional bisphenol glycidyl ether having an epoxide equivalent weight of from 150 to 2600, most preferably a multi-functional bisphenol glycidyl ether having an epoxide equivalent weight of from 150 to 1000.

Illustrative amide carboxylic acids that fall within structures represented by Formula III include those described above.

Such amide carboxylic acids, when combined with a multi-functional epoxy resin and, optionally, either or both of a monomer that differs from the amide carboxylic acid and has a terminal carboxylic acid moiety and a curing catalyst constitute curable resin compositions of the fourth aspect.

Curable resin compositions that comprise only amide carboxylic acids and a multi-functional epoxy resin, have a multi-functional epoxy resin content within a range of from 80 wt % to 120 wt %, preferably from 90 wt % to 110 wt %, more preferably from 95 wt % to 105 wt %, in each case based upon equivalent weight of carboxylic acid (COOH) present in the carboxylic acid terminated monomer. The multi-functional epoxy resin may be any of those identified above.

When the curable resin composition includes the monomer that differs from the amide carboxylic acid and has a terminal carboxylic acid moiety, the monomer is present in an amount of from 5 wt % to 95 wt %, preferably from 25 wt % to 75 wt %, more preferably from 25 wt % to 50 wt %, in each case based upon equivalent weight of epoxy moieties present in the curable composition.

Illustrative monomers include carboxylic acid terminated polyesters. The monomer is preferably selected from URALAC™ P5271 and URALAC™ 5998.

When the curable resin composition includes a curing catalyst, the curing catalyst is present in an amount of from 0.1 wt % to 5.0 wt %, preferably from 0.1 wt % to 2.0 wt %, more preferably from 0.1 wt % to 1.0 wt %, in each case based upon curable composition weight.

Illustrative curing catalysts include imidazolines. A preferred curing catalyst is 2-phenyl-2-imidazoline.

Preparation of a reactive monomer with a terminal reactive moiety in accord with the fifth aspect comprises reacting a carboxylic acid anhydride with at least one of:

a. a ring opened epoxidized oil represented by Formula VI

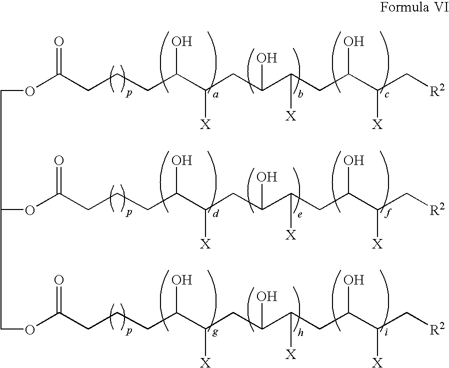

b. a ring opened epoxidized fatty acid ester or a ring opened epoxidized fatty acid represented by Formula VII

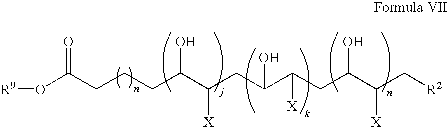

wherein R² is a hydrogen or a hydrocarbyl moiety; R⁹ is hydrogen or a hydrocarbyl moiety; n and p are 0 or a positive integer within a range of from 1-20; a, b, c, d, e, f, g, h, i, j, k and l are independently 0 or 1, provided that a sum of a, b, c, d, e, f, g, h and i or a sum of j, k and l is greater than zero; and X is:

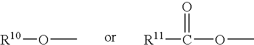

wherein R¹⁰ is independently hydrogen, a hydroxyl hydrocarbyl moiety or a hydrocarbyl moiety; and R¹¹ is independently hydrogen or a hydrocarbyl moiety; or

c. a product of an alcoholysis reaction between castor oil and a polyol.

Suitable carboxylic acid anhydrides include maleic anhydride, succinic anhydride, phthalic anhydride, cis-1,2,3,6-tetrahydrophthalic anhydride, 1,2,4,5-benzene tetracarboxylic dianhydride and trimellitic anhydride with phthalic anhydride being especially preferred.

Ring opened epoxidized oils represented by Formula VI include ring opened epoxidized soy bean oil and ring opened epoxidized linseed oil. Especially preferred reactive monomers result when the ring opened epoxidized oil is ring opened epoxidized soy bean oil.

Ring opened epoxidized fatty acid esters represented by Formula VII include ring opened epoxidized methyl oleate, ring opened epoxidized methyl linolenate, ring opened epoxidized methyl linoleate, ring opened epoxidized ethyl linoleate and ring opened epoxidized methyl undecenoate. Especially preferred reactive monomers result when the ring opened epoxidized fatty acid ester is ring opened epoxidized methyl oleate.

Ring opened epoxidized fatty acids represented by Formula VII include ring opened epoxidized oleic acid, ring opened epoxidized linoleic acid, ring opened epoxidized linolenic acid, ring opened epoxidized undecylenic acid and ring opened epoxidized 10-undecenoate acid. Especially preferred reactive monomers result when the ring opened epoxidized fatty acid is ring opened epoxidized oleic acid.

Polyols suitable for use in preparing an alcoholysis reaction product include, glycol, propylene glycol, ethylene glycol and diethylene glycol.

United States Patent Application Publication (USPAP) 2002/0035282 A1 discloses alcoholysis reactions. In general, such teachings include the alcoholysis of soybean oil with diethylene glycol.

U.S. Pat. No. 3,291,764 describes preparation of ring opened epoxidized oils.

When the process of the fifth aspect employs any of a ring opened epoxidized oil, a ring opened epoxidized fatty acid ester or a ring opened epoxidized fatty acid, process conditions include a temperature of from 100° C. to 140° C., atmospheric pressure and a reaction time within a range of from 2 hours to 6 hours.

When the curable composition of the sixth aspect comprises only the reactive monomer of the fifth aspect and the multi-functional epoxy resin, the multi-functional epoxy resin is present in an amount within a range of from 80 wt % to 120 wt %, preferably from 90 wt % to 110 wt %, more preferably from 95 wt % to 105 wt %, in each case based upon equivalent weight of carboxylic acid (COOH) present in the carboxylic acid terminated monomer. The multi-functional epoxy resin may be any of those identified above.

Curable compositions that include a monomer that differs from that of the fifth aspect do so in an amount within a range of from 5 wt % to 95 wt %, preferably from 25 wt % to 75 wt %, more preferably from 25 wt % to 50 wt %, in each case based upon equivalent weight of epoxy moieties present in the curable composition.

Illustrative monomers include carboxylic acid terminated polyesters. Especially preferred monomers include URALAC™ P5271 and URALAC™ 5998.

When the curable resin composition includes a curing catalyst, the curing catalyst is present in an amount of from 0.1 wt % to 5.0 wt %, preferably from 0.1 wt % to 2.0 wt %, more preferably from 0.1 wt % to 1.0 wt %, in each case based upon curable composition weight.

Illustrative curing catalysts include imidazolines. Preferred curing catalysts include 2-phenyl-2-imidazoline.

U.S. Pat. No. 3,787,459 (Frankel) discloses a process for converting unsaturated vegetable oil materials via hydroformylation into formyl (aldehyde) products. Illustrative vegetable oil materials include soybean oil, linseed oil, and safflower oils and their derivatives.

Additional references that discuss hydroformylation include U.S. Pat. No. 4,423,162 (Peerman et al.) (especially Ex 34), U.S. Pat. No. 4,723,047 (Bahrmann et al.,), Canadian Patent Application (CA) 2,162,083, WO 2004/096744 (Lysenko et al.), U.S. Pat. No. 4,496,487 (Peerman et al.), U.S. Pat. No. 4,216,344 (Rogier), U.S. Pat. No. 4,304,945 (Rogier) and U.S. Pat. No. 4,229,562 (Rogier).

The teachings of Peerman et al. '162, especially those found at column 3, line 50 through column 4, line 36, are particularly instructive for those seeking to practice reductive hydroformylation. In that portion, one prepares a hydroxy ester monomer starting material prepared by hydrogenating a hydroformylated unsaturated carboxylic acid or ester. One may obtain suitable unsaturated acids by splitting a triglyceride into its respective component fatty acids. Peerman et al. '162 notes that sources of fatty acids include fatty oils such as tallow and most plant sources particularly soybean, sesame, sunflower, tall oil and other similar materials, but prefers starting fatty acids that are in the form of a methyl ester.

Peerman et al. '162 teaches that introduction of a hydroxymethyl group can be readily accomplished by a hydroformylation process utilizing either cobalt or rhodium catalysts, followed by hydrogenation of the formyl group to obtain the hydroxymethyl group by catalytic methods or by chemical reduction. In doing so, Peerman et al. '162 also refers to, and incorporates by reference, procedures described in detail in U.S. Pat. No. 4,216,343 (Rogier), U.S. Pat. No. 4,216,344 (Rogier), U.S. Pat. No. 4,304,945 (Rogier), and U.S. Pat. No. 4,229,562 (Rogier).

Seed oils comprise a mixture of both saturated and unsaturated fatty acids, fatty acid esters or both fatty acids and fatty acid esters. A typical seed oil comprises from >10 wt % to less than (<)80 wt % mono-unsaturated fatty acids, fatty acid esters or both fatty acids and fatty acid esters, from >1 wt % to <45 wt % of di-unsaturated fatty acids, fatty acid esters or both fatty acids and fatty acid esters, and from >1 wt % to <45 wt % of tri-unsaturated fatty acids, fatty acid esters or both fatty acids and fatty acid esters, in each case based upon total seed oil weight.

Non-limiting examples of suitable unsaturated fatty acids that may be obtained from a seed oil feedstock include 3-hexenoic(hydrosorbic), trans-2-heptenoic, 2-octenoic, 2-nonenoic, cis- and trans-4-decenoic, 9-decenoic(caproleic), 10-undecenoic(undecylenic), trans-3-dodecenoic(linderic), tridecenoic, cis-9-tetradeceonic(myristoleic), pentadecenoic, cis-9-hexadecenoic(cis-9-palmitoelic), trans-9-hexadecenoic(trans-9-palmitoleic), 9-heptadecenoic, cis-6-octadecenoic(petroselinic), trans-6-octadecenoic(petroselaidic), cis-9-octadecenoic(oleic), trans-9-octadecenoic(elaidic), cis-11-octadecenoic, trans-11-octadecenoic(vaccenic), cis-5-eicosenoic, cis-9-eicosenoic(godoleic), cis-11-docosenoic(cetoleic), cis-13-docosenoic(erucic), trans-13-docosenoic(brassidic), cis-15-tetracosenoic(selacholeic), cis-17-hexacosenoic(ximenic), and cis-21-triacontenoic(lumequeic) acids, as well as 2,4-hexadienoic(sorbic), cis-9-cis-12-octadecadienoic(linoleic), cis-9-cis-12-cis-15-octadecatrienoic(linolenic), eleostearic, 12-hydroxy-cis-9-octadecenoic(ricinoleic), cis-5-docosenoic, cis-5,13-docosadienoic, 12,13-epoxy-cis-9-octadecenoic(vernolic), and 14-hydroxy-cis-11-eicosenoic acid (lesquerolic) acids. The most preferred unsaturated fatty acid is oleic acid.

In seed oils the alcohol segment of the fatty acid ester is glycerol, a trihydric alcohol. Generally, the fatty acid esters employed in preparing the aldehyde or alcohol compositions of this invention are obtained by transesterifying a seed oil with a lower alkanol. Transesterification produces the corresponding mixture of saturated and unsaturated fatty acid esters of the lower alkanol. Since glycerides can be difficult to process and separate, transesterification of the seed oil with a lower alkanol yields mixtures that are more suitable for chemical transformations and separation. Typically, the lower alcohol has from 1 to 15 carbon atoms. The carbon atoms in the alcohol segment may be arranged in a straight-chain or a branched structure, and may be substituted with a variety of substituents, such as those previously disclosed hereinabove in connection with the fatty acid segment, provided that such substituents do not interfere with processing and downstream applications. Preferably, the alcohol is a straight-chain or a branched C₁₋₈ alkanol, more preferably, a C₁₋₄ alkanol. Even more preferably, the lower alkanol is selected from methanol, ethanol, and isopropanol. Most preferably, the lower alkanol is methanol.

Any known transesterification method can be suitably employed, provided that the ester products of the lower alkanol are achieved. The art adequately discloses transesterification (for example, methanolysis, ethanolysis) of seed oils; for example, refer to WO 2001/012581, DE 19908978, and BR 953081. Typically, in such processes, the lower alkanol is contacted with alkali metal, preferably sodium, at a temperature between 30° C. and 100° C. to prepare the corresponding metal alkoxide. Then, the seed oil is added to the alkoxide mixture, and the resulting reaction mixture is heated at a temperature between 30° C. and 100° C. until transesterification is effected. The crude transesterified composition may be separated from the reaction mixture by methods known in the art, including for example, phase separation, extraction, and/or distillation. The crude product may also be separated from co-products and/or decolorized using column chromatography, for example, with silica gel. Variations on the above procedure are documented in the art.

If a mixture of fatty acids, rather than fatty acid esters, is desirably employed as the feedstock for this invention, then the selected seed oil can be hydrolyzed to obtain the corresponding mixture of fatty acids. Methods for hydrolyzing seed oils to their constituent fatty acids are also well known in the art.

Although the description herein refers in the alternative to fatty acids or fatty acid esters, the description does not intend to exclude the possibility of using and obtaining mixtures of fatty acids and fatty acid esters. Preferably, on a practical level, the compositions comprise essentially acids or essentially esters; but as noted a mixture thereof is also conceivable.

Preferred starting materials include hydroxymethyl fatty acids, hydroxymethyl fatty acid esters, castor oil and castor oil derivatives. Especially preferred starting materials include those selected from the group consisting of hydroxymethyl stearate, hydroxymethyl methyl stearate, ricinoleic acid and ricinoleic acid esters.

Preferred alkanolamines include at least one of ethanolamine, 1,2 propanolamine or diethanolamine.

Preferred epoxy-functionalized vegetable oils suitable for use as a first reactant include vemonia oil, epoxidized soybean oil, or epoxidized linseed oil.

Preferred epoxidized fatty acids suitable for use as a first reactant include epoxidized undecenoic acid, and epoxidized oleic acid.

Preferred epoxidized fatty acid esters suitable for use as a first reactant include epoxidized methyl oleate, epoxidized methyl 10-undecenoate and epoxidized methyl 9-decenoate.

Preferred carboxylic acids suitable for use as a second reactant include acetic acid and formic acid.

Preferred alcohols suitable for use as a second reactant include methanol, ethanol, propanol and butanol.

Preferred acid catalysts include ion exchange references, preferably a cation exchange resin such as DOWEX™ cation exchange resin MSC-1 (The Dow Chemical Company) and mineral acids (e.g. sulfuric acid).

Compositions of the present invention may include one or more non-reactive components conventionally added to coating compositions. Such non-reactive components include, without limitation, pigments, fillers, stabilizers and solvents.

The analytical procedures used for FTIR are based on standard methods such as described in an American Chemical Society (ACS) Professional Reference Book entitled “Spectroscopy of Polymers” by Jack L. Koening. Other test methods used herein are described below.

Determine cured coating glass transition temperature (T_{g}) via differential scanning calorimetry (DSC) using a programmed heating rate of 10° C. per minute.

Use a Fisher Multiscope thickness tester to determine thickness of non-magnetic coatings deposited on ferromagnetic substrates. The Fisher Multiscope includes a probe and operates via magnetic induction to indicate coating thickness after placing the probe against the coating and activating the Multiscope. Coating thickness values reported herein represent an average of 15 coating thickness measurements.

Evaluate a sample dissolved in pyridine via a potentiometric titration using 1.0 Normal (N) aqueous sodium hydroxide (NaOH) after the addition of a known excess of phthalic anhydride in pyridine has been added.

Evaluate a polymer solution (in acetone) for carboxyl group percentage (% COOH) via manual titration using a 0.1 Normal (N) aqueous NaOH as a titrant and bromothymol blue as an indicator.

Place a coated panel on a firm horizontal surface. Have an operator hold a pencil of known hardness firmly against the coating or film at a 45° angle and push the pencil away from the operator's body in a ¼ inch (6.5 mm) stroke. Begin this test with the softest lead pencil (6B) and continue testing with pencils of progressively harder lead (toward 9H) until the stroke causes the pencil to cut into or gouge the film or coating. Report coating pencil hardness by hardness of the lead of that pencil immediately preceding the pencil that cuts into or gouges the coating.

Pass the rounded end or peen of a two pound (4.4 kilograms (kg)) ball-peen hammer covered with 8 ply gauze soaked in MEK back and forth over the surface of a coated panel until the coating fails. Use only weight of the hammer and that force needed to guide the gauze-covered peen across the coating in this test. Coating failure occurs upon exposure of a panel substrate beneath the coating. Use acidic copper sulfate to verify substrate exposure and coating failure. Replicate the test two times, determine the arithmetic mean of such testing and report that mean as “Coating MEK Double Rub Failure Number”.

Measure flexibility (resistance to cracking) of organic coatings attached to a sheet metal substrate having a thickness of no more than 1/32 inch (0.8 mm) using test equipment supplied Gardner Lab, Inc. The test equipment consists of a smooth metal conical mandrel (length of 8 inches (20.3 cm), a small end diameter of ⅛ inch (3.2 mm) and a large end diameter of 1.5 inch (38.1 mm), a rotating panel-bending arm, and panel clamps, all mounted on a metal base. Clamp a coated sheet metal substrate into the apparatus and bend the coated substrate to approximately 135° from vertical. Examine the coated metal substrate proximate to the bend for cracks and, if present, measure crack length from the small end of the conical mandrel. Report the measured crack length as “failure distance”.

Evaluate effects of coated panel deformation upon the coating when the panel is a tin-free 0.0089 inches (0.23 millimeters (mm)) steel sheet. Bend the coated sheet in a 1/16 inch (1.6 mm) mandrel, then impact the bent sheet with a 40 foot-pound (5.5 kilogram-meters (kg-m)) load using a Garner “Coverall” Impact Tester to obtain a 0 T bend (180°). Evaluate coating adhesion loss by: a) applying pressure-sensitive adhesive tape over and proximate to the bend; b) removing the tape in a uniform and rapid motion; c) immersing the bent sheet in a 1 Normal (1N) hydrochloric acid (HCl) solution that contains 0.03 moles of copper sulfate (CuSO₄) for one minute; d) rinsing the bent sheet with water and blot drying the rinsed sheet; and e) at least twelve hours later, inspecting the bent sheet proximate to the 0 T bend for cracking and adhesion loss. When present, measure adhesion loss distance beginning at the 0 T bend and ending where visible loss of adhesion stops.

Differential scanning calorimetry (DSC) testing uses a TA Instrument DSC 2920 equipped with a refrigerated cooling system and a heating rate of 10° C. per minute over a temperature range of from −60° C. to 275° C.

Use an I.C.I Cone and Plate Rheometer to evaluate monomer and coating formulation viscosity at six temperatures: 25° C., 100° C., 125° C., 150° C., 175° C. and 200° C.

Place 0.2 g of a powder formulation on a stroke cure hot plate (Tetrahedron of San Diego, Calif.) that is heated to either 150° C. or 204° C. Use a stop watch to measure time required for a fluid melt to change into a thermoset (otherwise known as a rigid, immobile solid).

Use an 11-blade knife to cut a cured coating deposited on a panel to produce three cross-hatched sections. Firmly press a strip of masking tape to each cross-hatched section, then quickly remove the masking tape and examine the coating with a magnifying glass to determine how much, if any, of the coating that is removed with the masking tape. Give the coating a rating of “Pass” when cut edges appear to be completely smooth and none of the coating is removed from inside squares of the cross-hatched section. Give the coating a rating of “Failure” when at least a portion of the coating appear to be absent proximate to cut junctures or from interior portions of the cross-hatched section or both.

Drop a standard weight (four pounds (lbs) (8.8 (kg) a distance onto an indenter that deforms both cured film and the substrate or panel underlying the cured film or coating. The indenter can be placed either against the cured film to impose an intrusion and evaluate resistance to direct impact or against the substrate or panel surface opposite that on which the cured coating is bonded to impose an extrusion force to evaluate resistance to a reverse impact. Gradually increase the distance the weight drops until reaching a distance at which coating failure occurs. Cured films or coatings generally fail by cracking, which becomes more visible evident when viewed through a magnifier, especially after one applies an acidic copper sulfate solution to the cured film or coating after deformation.

Use a Gardner Micro Tri Gloss Meter to make spectral gloss measurements at each of 20°, 60° and 85° from horizontal, then determine and record an average for gloss measurements at each of such angles.

Use a scratch testing instrument as described in Surface & Coatings Technology 201 (2006) 2970-2976 and equipped with a scratch tip to apply a controlled, instrumented scratch incident to coated samples using a scratch speed of 100 millimeters per second (mm/sec), a scratch length and an increasing applied load of from 1 Newton (N) to 70 N. Scan images of scratches on an Epson Perfection™ 4990 Photo scanner at a resolution of 3200 dpi (pixels per inch) (1260 pixels per centimeter (cm)), Determine epoxy coating failure as the applied load point at which the scratch tip first visibly penetrates coating on a panel and touches an underlying metal panel surface.

The following examples illustrate, but do not limit, the present invention. All parts and percentages are based upon weight, unless otherwise stated. All temperatures are in ° C. Examples (Ex) of the present invention are designated by Arabic numerals and Comparative Examples (Comp Ex) are designated by capital alphabetic letters. Unless otherwise stated herein, “room temperature” and “ambient temperature” are nominally 25° C.

### Raw Materials:

A. Castor Oil (Aldrich, Catalog Number 25,985-3).

B. 12-hydroxy methyl stearate (PARACIN™, CasChem of Rutherford Chemicals), purified by recrystallization to provide a DSC crystalline melt point of 57° C.

C. 12-hydroxymethyl methyl stearate, a reductive hydroformylation (HF) product of methyl esters of sunflower oil.

D. Methyl ester mixture, a reductive HF product of methyl esters of soybean oil.

E. Methyl 11-hydroxyundecanoate—a product obtained by reductive hydroformylation of soybean oil methyl esters following metathesis of the methyl esters in accord with procedures described in U.S. Pat. No. 4,496,487 and then purified by distillation. Gas chromatography (GC) analysis of the product shows that it contains 94 wt %, based upon total product weight, methyl 11-hydroxyundecanoate.

F. Diethanolamine (DEA) (Aldrich, Catalog Number 39,817-9).

G. Solid Epoxy Resins (D.E.R.™ 663U and D.E.R.™ 661, The Dow Chemical Company).

H. Castor oil glycerolysis product (FLEXRICIN™ 13, CasChem of Rutherford Chemicals).

I. Polydimethylsiloxane surface modifier (BYK™ 310, BYK Chemie USA).

J. Ethylene glycol monobutyl ether (DOWANOL™ EB, The Dow Chemical Company).

K. Cyclohexanone (Aldrich, Catalog Number 39,824-1).

L. Carboxylic acid functional polyester, (URALAC™ 5271, DSM, titrated hydrogen equivalent weight of 720).

M. Hydroxyalkylamide derived from adipic acid and DEA (PRIMID™ XL-552, EMS-PRIMID, reported hydroxyl value of 620-700 milligrams of potassium hydroxide per gram (mg KOH/g).

N. Glycolated epoxidized soybean oil (See Ex 34 for preparation of glycolated epoxidized soybean oil).

### EX 1

### Preparation of a Hydroxyalkylamide from Diethanolamine and Methyl 12-hydroxystearate

Place 100.5 grams (g) (0.32 mole) of methyl 12-hydroxystearate, 139.4 g (1.325 mole) diethanolamine, and 0.13 g (0.002 mole) of an 85 wt % solution of potassium hydroxide (in methanol) in a 500 ml round bottom flask equipped with a magnetic stirring bar and a water-cooled reflux condenser. Seat the flask in an electric heating mantle. Control flask contents temperature using a temperature controller connected to a thermocouple immersed in the flask contents. Heat the flask contents, with stirring, to 110° C., whereby the flask contents become a clear, colorless solution.

Maintain the 110° C. temperature with continued stirring overnight (approximately 14 hours) before taking a sample of the solution and subjecting the sample to Fourier Transform Infrared (FTIR) analysis. The analysis shows a trace amount of ester absorbance as indicated by a small peak at 1729 cm⁻¹.

Allow contents of the flask to cool to a temperature of 65° C., then add 400 milliliters (ml) of chloroform (CHCl₃) to yield a CHCl₃ solution of flask contents. Wash the CHCl₃ solution four times with 250 g of a 5 wt % aqueous sodium chloride (NaCl) solution with separation of the CHCl₃ solution from the aqueous NaCl solution to yield a washed CHCl₃ solution.

Dry the washed CHCl₃ solution of flask contents with anhydrous magnesium sulfate to remove residual water and then separate the dried CHCl₃ solution from the anhydrous magnesium sulfate via filtration.

Subject the dried and separated CHCl₃ solution of flask contents to rotary evaporation at a temperature of 60° C. and a vacuum of 4.5 millimeters (mm) of mercury (Hg) (600 pascals (Pa)) for four hours to remove CHCl₃ from the flask contents, thereby leaving 1069.6 g (87% of theoretical yield) of a solid reaction product that is, at room temperature (nominally 25° C.), a wax.

FTIR analysis of the wax characterizes the wax as a hydroxylamide, also known as an amide polyol, with a structure as shown in Formula VIII below

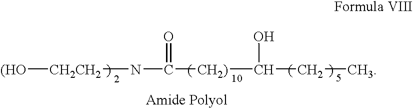

### EX 2

### Preparation of a Coating Composition Using the Hydoxyalkylamide of Ex 1

Place a micro-mill grinder (Bel-Art Products) in a dry ice box for two hours and then operate the mill for 1 minute to combine 3.56 g of the Ex 1 hydroxyalkylamide and 20 g of a carboxylated polyester resin (URALAC™ P 5271, commercially available from DSM) and produce a fine, non-sintering powder. Dissolve 6.5 g of the powder into an 80:20 (volume:volume) mixture of ethylene glycol monobutyl ether (DOWANOL™ EB, The Dow Chemical Company) and cyclohexanone to yield a coating solution or composition.

Use a number (No.) 28 BYK-Gardner draw down bar to draw or deposit coatings of the coating solution onto two tin-free stainless tin-free steel panels (4 inch (10.2 cm) by 12 inch (30.5 cm) by 0.03 inch (0.76 mm)). Similarly, use a No. 48 BYK-Gardner draw down bar to draw coatings of the coating solution onto two ground, cold-rolled steel panels.

Place the coated panels in heated, forced air convection oven operating at a set point temperature of 204° C. for a period of ten minutes to effect curing of the combined hydroxyalkylamide and carboxylated polyester resin. A Fisherscope Film Thickness Meter shows that coatings on the stainless tin-free steel panels have an average thickness of 0.35 mil (0.89×10-5 meter (m). Coatings on the cold rolled steel panels have an average thickness of 0.459 mil (1.16×10-5 m).

The coatings on the cold-rolled panels have an ASTM D3363 pencil hardness of H.

Wedge bend testing of the coatings on the tin-free steel panels showed no failure based on four measurements.

The cold rolled panel coatings on the cold rolled panels have physical properties ad follows:

Pencil Hardness (ASTM D 3363)=H

Conical Mandrel Bend (ASTM D 522-93a)=No Failure

Cross Hatch Adhesion (ASTM D 3359)=Pass

Direct Impact Strength (ASTM D 2784)=Greater than (>) 160 inch-pounds (1.84 kilogram-meters metric equivalent)

Indirect Impact Strength (ASTM D 2784)=Greater than (>) 160 inch-pounds (kilogram-meters metric equivalent)

### COMP EX A

### Preparation of a Powder Coating Composition from an Epoxy Resin and a Carboxylic Acid Terminated Polyester Resin

Replicate Ex 2 and operate the mill for one minute to prepare a free-flowing powder, but reduce the amount of carboxylated polyester resin to 10 g and substitute 10 g of a epoxy resin (D.E.R.™ 663U, The Dow Chemical Company) for the Ex 1 hydroxyalkylamide. The powder has gel times of 7.1 minute (min.) at 150° C. and 1.25 min. at 204° C. and a Tg of 80° C.

Combine 7.3 g of the free-flowing powder, 0.0365 g of 2-phenyl-2-imidazoline, 17.03 g of the 80:20 DOWANOL™ EB:cyclohexanone mixture and three drops of a polyester-modified polydimethylsiloxane surface modifier (BYK™ 310, BYK Chemie USA) in a glass bottle and place the bottle on a shaker to promote dissolution of solid components. Coat panels as in Ex 2. Subject coated panels to testing as in Ex 2 and summarize test results in Tables 1 and 2 below.

### COMP EX B

Replicate Comp Ex A, but increase the amount of carboxylated polyester resin to 20 g and substitute 2.21 g of a hydroxylamide (PRIMID™ XL-552, EMS-Primid, hydroxyl value of 620 to 700 milligrams of potassium hydroxide per gram (mg KOH/g)) for the epoxy resin. The powder blend has a gel time at 204° C. of 2.3 minutes and a Tg of 15° C. (minor peak) and 61° C. (major peak).

### EX 3

### Preparation of an Amide Polyol from DEA and Castor Oil

Place 200.07 g of castor oil and 276.03 g (2.62 mols) of diethanolamine (DEA) in a 2 liter round bottom flask equipped with mechanical stirring and a reflux condenser. Seat the flask in an electric heating mantle controlled by a temperature controller with a thermocouple immersed in the flask contents. Heat the flask contents, with stirring, to a set point temperature of 120° C. and maintain that temperature with continued stirring overnight (approximately 14 hours). FTIR analysis of flask contents shows a trace amount of ester absorbance at 1733 cm⁻¹.

Modify product recovery by increasing CHCl₃ addition to one kilogram (kg), changing the aqueous wash solution to 400 g aliquots of a 2 wt % solution of NaCl and changing rotary evaporation conditions to five hours duration and 2.3 mm Hg (306.6 Pa). The filtrate was rotary evaporated for 5 hours at 60° C. and 2.3 millimeters of Hg to remove the CHCl₃. The final product is a liquid at room temperature and has a % OH of 12.56. FTIR and ¹H NMR analyses support the ricinolamide triol structure given below.

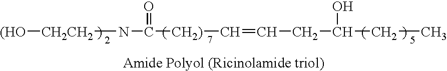

### EX 4

### Anhydride Esterification of the Ricinolamide Triol of Ex 3

Place 232.7 g (1.717 OH equivalents) of the amide polyol of Ex 3 in a 500 ml round bottom flask equipped as in Ex 3 and heat contents of the flask to a set point temperature of 90° C. before adding to the flask 18.73 g of pyromellitic dianhydride (PMDA or 1,2,4,5-benzenetetracarboxylic dianhydride; 0.172 equivalents) with continued stirring at a stirring rate of 400 revolutions per minute (rpm). After completing the PMDA addition, add 228.89 g of phthalic anhydride (1.545 equivalents) to the flask, with continued stirring, and increase the set point temperature to 135° C. and maintain the contents at that temperature for approximately three hours or until carboxyl (—COOH) content, as determined by titration, reaches a stable or consistent level.

Pour flask contents onto aluminum foil, then place the aluminum foil and its contents into a freezer (—15° C.) to solidify the contents, break the contents into chunks and place the chunks in a bottle, and return the bottle and its contents to the freezer until needed for further use or testing.

The flask contents or resin have a % COOH of 15.4% as compared to a theoretical % COOH of 16.1%. FTIR analysis of the flask contents shows a residual amount of anhydride carbonyl absorption at 1852 cm⁻¹. The resin has a viscosity (cone and plate rheometer) of 600 centipoises (0.6 Pa.s) at 150° C. and 150 centipoises (0.15 Pa.s) at 200° C. The resin also has a Tg of 6° C.

### EX 5

Use the same apparatus as in Ex 2 and a grind time of one minute, but reduce time in the dry ice box to 45 minutes, prepare a ground mixture of 15.76 g (0.0204 equivalents) of the same epoxy resin as in Comp Ex B and 6.0 g of the resin prepared in Ex 4. Warm the ground mixture to room temperature using an air blower to yield a fine, free-flowing powder that has a Tg of 12° C. and a gel time, at 204° C., of 1.7 minutes.

Place 1 g of the powder in an aluminum pan set the pan in a forced air convection oven operating at a set point temperature of 204° C. for 11 minutes to effect cross-linking or curing of the resin to provide a clear, cross-linked polymer resin. DSC analysis of the cured resin shows a first Tg of 63° C. A second DSC analysis of the same cured resin shows a second Tg of 73° C. The second Tg is higher that the first Tg, most probably as a result of additional curing or cross-linking.

### EX 6

Convert 19.7 g (0.0254 equivalents) of the same epoxy resin as in Ex 5, 7.5 g (0.0255 equivalents) of the resin prepared in Ex 4 and 0.54 g of 2-phenyl-2-imidazoline into a fine, free-flowing powder using the same apparatus and procedure as in Ex 5. The powder has a gel time at 204° C. of 1.0 minute and a Tg of 12° C. After curing as in Ex 5, the clear, cross-linked polymer resin has a Tg of 79° C. for a first DSC analysis and 78° C. for a second DSC analysis of the same cross-linked polymer resin. Skilled artisans understand that DSC measurements have an experimental error of ±3° C.

### EX 7

Prepare coated panels using the procedure of Comp Ex A, but with the powder of Ex 6, rather than that of Comp Ex A, no additional 2-phenyl-2-imidazoline and a time at 204° C. of 11 minutes rather than 10 minutes. See Table 1 for coating thickness and coating property test results.

### EX 8

Replicate Ex 4 with changes to esterify the amide polyol of Ex 3 with maleic anhydride (MAH) rather than PMDA. The changes include reducing amide polyol addition to 227.14 g (1.673 OH equivalents), reducing stirring rate to 350 rpm, heating flask contents to 50° C. before adding 164.02 g MAH, increasing flask content temperature after MAH addition to 100° C., and, after three hours at 100° C., pouring flask contents of the flask into a bottle rather than using the procedure of Ex 4 that involves pouring onto aluminum foil, freezing, breaking into chunks and subsequent storage in a freezer.

The flask contents or resin have a % COOH of 18.8% as compared to a theoretical % COOH of 19.3%. FTIR analysis of the flask contents shows a residual amount of anhydride carbonyl absorption at 1849 cm⁻¹.

The resin has a viscosity (cone and plate rheometer) of 440 centipoises (cps) (1.1 pascal second (Pa.s)) at 150° C. and a Tg of −19° C.

### EX 9

Replicate Ex 7, but change bottle contents to 1.86 g (0.0073 equivalents) of the resin from Ex 8, 5.67 g (0.0073 equivalents) of the same epoxy resin as used in Comp Ex A, 17.57 g of the 80:20 DOWANOL™ EB:cyclohexanone mixture noted in Comp Ex A and three drops of the polyester-modified polydimethylsiloxane surface modifier noted in Comp Ex A. See Tables 1 and 2 for coating properties.

### EX 10

Combine 5.66 g (0.0229 equivalents) of the resin from Ex 8, 17.67 g (0.229 equivalents) of the same epoxy resin as used in Ex 9 and 60 ml of anhydrous toluene in a 100 ml round bottom flask equipped with mechanical stirring, a nitrogen pad, a condenser and a temperature controller. Heat flask contents to a temperature of 100° C. and maintain that temperature for a period of three hours to yield a diluted “B-stage” product. Subject the diluted B-stage product to rotary evaporation for four hours at 60° C. and 4.5 mm Hg (600 Pa) to remove toluene and yield a substantially undiluted B-stage product that has a % COOH of 2.99. The % COOH translates to a finding that 32.2% of COOH present in the resin reacts or B-stages with the epoxy resin. The B-staged product has a cone and plate viscosity of 4500 cps (4.5 Pa.s). A first DSC analysis of the B-staged product shows a Tg of 23° C. followed by an exotherm of 5 joules/gram with onset and peak temperatures of, respectively, 153° C. and 178° C. A second DSC scan of the same B-staged product (the product that passed through the first DSC analysis) shows a Tg of 69° C. As in Ex 5, an increase in Tg very probably represents an additional amount of curing or cross-linking.

### EX 11

Replicate Ex 9, but substitute 9 g (0.0078 equivalents) of the B-staged product of Ex 10 for the Ex 8 resin and the epoxy resin. change bottle contents to 1.86 g (0.0073 equivalents) of the resin from Ex 8, 5.67 g (0.0073 equivalents) of the same epoxy resin as used in Comp Ex A, 17.57 g of the 80:20 DOWANOL™ EB:cyclohexanone mixture noted in Comp Ex A and three drops of the polyester-modified polydimethylsiloxane surface modifier noted in Comp Ex A. See Tables 1 and 2 for coating properties.

### EX 12

Replicate Ex 8 with several changes. First, reduce the amide polyol amount to 25 g (0.1846 OH equivalents). Second, substitute 18.59 g (0.1846 COOH equivalents) of succinic anhydride for all of the MAH. Third, change to flask size to 50 ml. Fourth, add 0.14 g of 2-methylimidazole to the flask after increasing flask contents temperature to 100° C. Fifth, maintain the flask contents temperature at 100° C. for approximately 2.75 hours until % COOH reaches a stable level as in Ex 4. The product has a % COOH of 20.36 and a viscosity (cone and plate rheometer) at 150° C. of 50 centipoises (0.05 Pa.s).

### EX 13

Replicate Ex 9 with several changes. First, substitute 1.86 g (0.0084 COOH equivalents) of the product of Ex 12 for the product of Ex 8. Second, increase the amount of epoxy resin to 6.5 g (0.0084 epoxy equivalents) and the amount of the 80:20 DOWANOL™ EB:cyclohexanone mixture to 19.5 g. See Tables 1 and 2 for cured coating properties.

### EX 14

Replicate Ex 4, with several changes, to esterify the hydroxyalkylamide of Ex 1. First, change the flask size to 50 ml and the flask contents to 25.8 g (0.194 OH equivalents) of the amide polyol of Ex 14, 25.86 g (0.175 equivalents) of phthalic anhydride, 2.12 g (0.0194 equivalents) of PMDA. The flask contents or resin have a % COOH of 15.84% as compared to a theoretical % COOH of 16.23%. The resin has a viscosity (cone and plate rheometer) of 1000 cps (1.0 Pa.s) at 150° C. and a Tg of 6° C.

### EX 15

Replicate Ex 5 with changes to prepare a ground powder including the resin of Ex 14. First, place the grinder in a dry ice box for 0.5 hour rather than 45 minutes, increase the grinding time from one minute to two minutes and change materials being ground to 15.0 g (0.0194 equivalents) of the same epoxy resin as in Ex 5, 5.51 g (0.0194 equivalents) of the ground powder of Ex 17, and 0.41 g of 2-phenyl-2-imidazoline (URALAC™ 5271, DSM). The powder has a gel time, at 204° C., of 0.8 minute.

Convert 1.03 g of the powder to a clear, cross-linked polymer resin using the same process as in Ex 5. DSC analysis of the cured resin shows a Tg of 83° C. A second DSC analysis of the same cured resin shows a Tg of 83° C.

### EX 16

Replicate Ex 7, but substitute the resin of Ex 14 for the resin of Ex 4. See Tables 1 and 2 for cured coating properties.

### EX 17

Replicate Ex 1, with changes to prepare an amide polyol from DEA and 12-hydroxymethyl methylstearate. Change the flask to a two-liter round bottom flask and the flask contents to 400 g (1.217 mol) of 12-hydroxymethyl methylstearate (a reductive hydroformylation product using methyl esters of sunflower oil as a base material), 511 g (4.86 mols) of DEA and 0.915 g (0.014 mol) of the 85% KOH in methanol solution. FTIR analysis before cooling to 50° C., rather than 65° C. as in Ex 14, and product recovery shows a trace amount of ester absorbance at 1729 cm⁻¹. See teachings cited above, especially U.S. Pat. No. 4,496,487 (Peerman et al.) and U.S. Pat. No. 4,423,162 (Peerman et al.), both previously incorporated herein by reference, for reductive hydroformylation procedures,

For product recovery, substitute 780 g of toluene for the 400 ml of CHCl₃ used in Ex 1 and change the wash fluid to 560 g of aqueous 3 wt % sodium hydrogen carbonate (NaHCO₃) solution. In addition increase rotary evaporation time to six hours with a vacuum of 1.5 mm Hg (200 Pa.s). The product, a liquid at room temperature, weighs 450.3 g (92.1% of theoretical yield) and has a % OH of 12.092. FTIR and ¹H NMR analyses support an amide polyol with a structure as shown below.

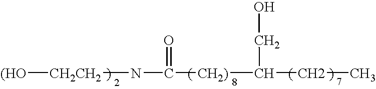

### EX 18

Replicate Ex 1, with changes, to make an esterified product using the amide polyol product of Ex 17. First, change the flask contents to 25 g (0.1777 OH equivalents) of the amide polyol product of Ex 17 and 17.89 g (0.1777 COOH equivalents) of succinic anhydride. Second, heat flask contents to 100° C., add 0.14 g of 2-methylimidazole and then maintain the flask contents at 100° C. until % COOH stabilizes (approximately three hours). The resin has a % COOH of 18.44% as compared to a theoretical % COOH of 18.59%, and a viscosity (cone and plate rheometer) of 70 cps (0.07 Pa.s) at 150° C.

### EX 19

Combine 1.85 g (0.00758 COOH equivalents) of the resin of Ex 18, 5.86 g (0.00758 epoxy equivalents) of the same epoxy resin as in Ex 5, 18 g of the 80:20 DOWANOL™ EB:cyclohexanone mixture noted in Comp Ex A and three drops of the same polysiloxane surface modifier as in Comp Ex A in a glass bottle using the procedure of Comp Ex A and prepare coated panels, also as in Comp Ex A. See Tables 1 and 2 for coating properties.

### EX 20

Replicate Ex 3 with changes to prepare an amide polyol from DEA and reductively hydroformylated soybean oil methyl esters. As in Ex 14 above, see teachings cited above, especially U.S. Pat. No. 4,496,487 (Peerman et al.) and U.S. Pat. No. 4,423,162 (Peerman et al.), both previously incorporated herein by reference, for reductive hydroformylation procedures. First, use a 3 liter round bottom flask rather than a 2 liter round bottom flask and change flask contents to 400 g of reductively hydroformylated soybean oil methyl esters and 514.33 g (4.89 mols) DEA. Second, change the temperature to 110° C. FTIR analysis of flask contents after heating with stirring as in Ex 3 shows a trace amount of ester absorbance at 1735 cm⁻¹.

For product recovery, use the procedure of Ex 17, but increase toluene addition to 1500 ml, wash solution amounts to 1000 g aliquots. The product, a semi-solid at room temperature has a % OH of 11.59. FTIR and 1H NMR analyses suggest an amide polyol structure for the product.

### EX 21

Replicate Ex 4 with changes to esterify the amide polyol of Ex 20. First, place 252.16 g (1.842 OH equivalents) of the amide polyol of Ex 20 in the round bottom flask rather than the amide polyol of Ex 3. Second, heat flask contents to 70° C. before adding PMDA and change the amount of PMDA to 20.09 g (0.184 equivalents). Third, increase the amount of phthalic anhydride to 245.55 g (1.658 equivalents). The product has a % COOH of 15.78% versus a theoretical % COOH of 16.02%, a cone and plate viscosity at 150° C. of 1100 cps (1.1 Pa.s) and a Tg of 12° C.

### EX 22

Replicate Ex 6 with changes to prepare a powder coating formulation based upon the product of Ex 21. First, change materials processed with the grinder to 7.63 g (0.00987 equivalents) of the same epoxy resin as in Ex 6, 2.94 g (0.00988 equivalents) of the product of Ex 24, and 0.21 g of the same 2-phenyl-2-imidazoline as in Ex 6. Second, increase grinding time to two minutes to provide a fine, free-flowing powder. DSC analysis of the powder shows a melting endotherm at 60° C., followed by an exotherm of 66 joules/gram with respective onset and peak temperatures of 91° C. and 153° C. The powder has a gel time at 204° C. of 0.78 minute and a Tg of 12° C. After curing as in Ex 5, the clear, cross-linked polymer resin has a Tg of 84° C.

### EX 23

Replicate Ex 7 to prepare coated panels using the powder of Ex 22. See Tables 1 and 2 for coating properties.

### EX 24

Replicate Ex 21 with changes to esterify the amide polyol of Ex 20 using maleic anhydride (MAH) rather than PMDA and phthalic anhydride. First, use 226.68 g (1.640 OH equivalents) of the amide polyol of Ex 20 and heat flask contents to 60° C., rather than 70° C., before adding 161.74 g of MAH to the flask. Second, heat flask contents to 90° C. after MAH addition, rather than 135° C. as in Ex 24. The product is a liquid with a % COOH of 18.38%, versus a theoretical % COOH of 19.10%, a cone and plate viscosity at 150° C. of 125 cps (1.45 Pa.s), and a Tg of −28° C. FTIR analysis of the product shows a residual amount of anhydride carbonyl absorption at 1849 cm⁻¹.

### EX 25

Place 1.93 g (0.00783 COOH equivalents) of the product of Ex 21, 6.06 g (0.99784 epoxy equivalents) of the same epoxy resin as in Ex 5, 0.303 g of 2-phenyl-2-imidazoline, 14.13 g of the 80:20 DOWANOL™ EB:cyclohexanone mixture noted in Comp Ex A and three drops of the same polysiloxane surface modifier as in Comp Ex A in a glass bottle and shake bottle contents to dissolve solids as in Comp Ex A. Prepare coated panels as in Ex 7 and report results in Tables 1 and 2 below.

### EX 26

Replicate Ex 17, with changes, to prepare an amide polyol from DEA and methyl 11-hydroxyundecanoate. First, change the flask to a 1 liter round bottom flask and flask contents to 200 g (0.9246 mol) of methyl 11-hydroxyundecanoate, 388 g (3.6903 mol) of DEA, 0.62 g (0.009 mol) of the same 85% KOH solution as in Ex 20. Second, heat flask contents to 80° C. with stirring to yield a clear, colorless solution, and continue stirring at that temperature for 20 hours. FTIR analysis of the solution before cooling shows a trace amount of ester absorbance at 1729 cm⁻¹. Third, cool the solution to room temperature (nominally 23° C.) and then rotary evaporate flask contents for 3 hours at 60° C. and 4 mm Hg (533.3 Pa) to remove methanol.

Combine flask contents with 400 ml of an aqueous 2 wt % sodium chloride (NaCl) solution and stir the combined contents for three hours. Vacuum filter the combined contents through a coarse glass-fritted Buchner funnel and rinse solid portions of the combined contents with an additional 400 ml of the aqueous 2 wt % NaCl solution. Mix rinsed solid portions of the flask contents with 500 ml of fresh 2 wt % NaCl solution for three hours and then vacuum filter through a coarse glass-fritted Buchner funnel. Rinse filtered solids with 800 ml of deionized water, then allow the solids to air dry for three days in a fume hood. Mix the solids with 650 ml of toluene for three hours then separate solids from the toluene via vacuum filtration through the coarse glass-fritted Buchner funnel. Rinse the separated solids with two separate aliquots of toluene, then rotary evaporate the separated solids at 70° C. to a constant weight. The rotary evaporated solids or final product is a white solid that weighs 231.8 g (88% of theoretical yield). FTIR and 1H NMR analyses support an amide polyol (triol) structure as follows:

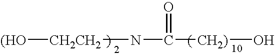

### EX 27

Replicate the procedure of Comp Ex A, but increase grinding time to two minutes, to convert 15 g (0.0208 equivalents (COOH equivalents)) of the carboxylic acid functional polyester as in Comp Ex A and 1.96 g (0.0194 equivalents) of the amide polyol of Ex 26 to a fine, free-flowing powder that has a gel time at 204° C. of 1 minute and 46 seconds. DSC analysis of the powder shows melting endotherms at 69° C. and 79° C. followed by an exotherm of 8.35 joules/g with respective onset and peak temperatures of 180° C. and 230° C. Cure 1.4 g of the powder at 204° C. for 11 minutes as in Comp Ex A to yield a clear, cured polymer that has a Tg of 56° C. on a first DSC scan and 65° C. on a second or repeat scan.

### EX 28

Replicate Ex 14 with changes to esterify the amide polyol of Ex 26. First, place 17.53 g (0.1733 OH equivalents) of the amide polyol of Ex 26, 21.97 g (0.1444 equivalents) of cis-1,2,3,6-tetrahydrophthalic anhydride, and 3.15 g (0.0289 equivalents) of PMDA in the 50 ml round bottom flask and heat flask contents to 120° C. before adding 0.14 g of 2-methylimidazole to the flask. Continue stirring at 120° C. until % COOH, determined as in Ex 17, stabilizes (approximately two hours) at 17.2% versus a theoretical % COOH of 18.2%. Pour the flask contents, a liquid at ambient temperature (nominally 23° C.), into a bottle. The liquid, also known as a multifunctional acid, has a cone and plate viscosity at 150° C. of 650 cps (0.65 Pa.s).

### EX 29

Replicate the procedure of Ex 25, but place the shaker under a heat lamp, to prepare coated panels from a shaken combination of 2.2 g (0.0077 COOH equivalents) of the multifunctional acid of Ex 28, 5.97 g (0.0077 epoxy equivalents) of the same epoxy resin as in Ex 25, 18.64 g of the same 80:20 DOWANOL™ EB:cyclohexanone mixture noted in Comp Ex A and three drops of the same polysiloxane surface modifier as in Comp Ex A. Summarize coating properties in Table 1 below.

### EX 30

Replicate Ex 28 with changes, including substituting phthalic anhydride for tetrahydrophthalic anhydride, to esterify the amide polyol of Ex 26. First, change flask contents to 22 g (0.2175 OH equivalents) of the amide polyol of Ex 26, 28.99 g (0.196 equivalents) of phthalic anhydride and 2.37 g (0.0217 equivalents) of PMDA and heat to 135° C. with stirring, but no 2-methylimidazole addition, until % COOH as determined by titration stabilizes (approximately three hours) to yield a liquid with a % COOH of 17.87% versus a theoretical % COOH of 18.34 and a cone and plate viscosity at 150° C. of 2000 cps (2 Pa.s).

### EX 31

Replicate Ex 22 with changes to prepare a powder coating formulation from the esterified amide polyol of Ex 30. Place 15 g (0.0194 epoxy equivalents) of the same epoxy resin as in Ex 29, 4.89 g (0.0194 COOH equivalents) of the esterified liquid from Ex 30, and 0.1 g of 2-phenyl-2-imidazoline into the grinder, place the grinder in a dry ice box for two hours and then grind contents of the grinder for two minutes. After warming to ambient temperature with an air blower, ground contents form a fine, free-flowing powder that has a gel time at 400° C. of 43 seconds and a Tg of 13° C. DSC analysis of the powder also shows a melting endotherm at 60° C. followed by an exotherm of 45 joules/g with respective onset and peak temperatures of 110° C. and 168° C. Curing of 1.34 g of the powder yields a clear polymer with a first DSC scan Tg of 91° C. and a repeat or second scan Tg of 89° C.

### EX 32

Using the same equipment as in Ex 30, place 25 g of a glycerolysis product from castor oil (FLEXRICIN™ 13, CasChem, calculated OH equivalent weight of 165.3 g, approximately 0.1515 OH equivalents), 15.25 g (0.1515 COOH equivalents) of succinic anhydride and 0.14 g of 2-methylimidazole into the 50 ml round bottom flask, heat flask contents to 100° C. and maintain that temperature, with continued stirring, for two hours. FTIR analysis shows no evidence of hydroxyl group absorption. Place flask contents (liquid anhydride esterification product or multifunctional acid) into a bottle. The contents have a % COOH of 18.4% versus a theoretical % COOH of 20.0% and a cone and plate viscosity, at 150° C., of 30 cps (0.03 Pa.s).

### EX 33

Replicate the procedure of Ex 25 to prepare coated panels from a shaken combination of 2.16 g (0.0088 COOH equivalents) of the multifunctional acid of Ex 32, 4.79 g (0.0088 epoxy equivalents) of the same epoxy resin as in Ex 25, 16.2 g of the same 80:20 DOWANOL™ EB:cyclohexanone mixture noted in Comp Ex A and three drops of the same polysiloxane surface modifier as in Comp Ex A. Summarize coating properties in Table 1 below. Use a #22 draw down bar to deposit coatings and reduce coated panel time at 204° C. to 10 minutes. After curing, the coatings have a thickness of 0.346 mils (8.79×10⁻⁶ m), a second DSC scan Tg of 48° C., a Wedge Bend Failure of 0 mm, and a MEK Double Rub Failure Number of 25.

### EX 34

Prepare glycolated epoxidized soybean oil as follows. First, place 222 g (3.58 mol) of ethylene glycol and 4.7 g sodium methoxide (25 wt % solution in methanol, based upon combined weight of sodium methoxide and methanol) in a 500 ml three-necked round bottom flask equipped with a magnetic stirrer. Place the flask together with its contents on a heating mantle. To the necks of the flask, attach a thermometer with Thermowatch (a temperature control device), a Dean Stark trap with condenser and nitrogen inlet, and an addition funnel with 50 g (0.053 mol) of epoxidized soybean oil (ESO). Turn on a flow of nitrogen through the nitrogen inlet and a flow of water to the condenser, then heat the flask contents to a set point temperature of 150° C. before adding the ESO dropwise over a 20 minute period. Continue heating with stirring for one hour, then remove the flask and its contents from the heating mantle and allow them to cool to room temperature (nominally 25° C.) before neutralizing the contents with acetic acid (until the contents just start to turn acidic as indicated by pH test paper) and then recovering a purified, glycolated ESO using a wipe film evaporator (WFE). WFE operating conditions include: jacket temperature=90° C.; cold finger temperature=33.5° C.; pressure=2.2 torr (293.3 pascals (Pa)); stir speed=530 rpm; and addition rate=6 ml/min (milliliters per minute).

Use the apparatus and procedure of Ex 33 to esterify glycolated ESO. Place 22.91 g (0.2147 equivalents) of glycolated ESO, 28.62 g (0.1932 equivalents) of phthalic anhydride and 2.34 g of PMDA into the 50 ml round bottom flask and process flask contents as in Ex 30. FTIR analysis of flask contents reveals no hydroxyl group absorption, thereby suggesting complete reaction of hydroxyl moieties. The % COOH of flask contents is 16.44% versus a theoretical % COOH of 16.41%. The flask contents, a liquid, have a cone and plate viscosity at 150° C. of 150 centipoises (0.15 Pa.s).

### EX 35

Use the apparatus of Ex 31 and modifications of the procedure of Ex 31 to increase time in the dry ice box to 14 hours and reduce grinding time to 1 minute, to convert 12 g (0.0155 epoxy equivalents) of the same epoxy resin as in Ex 34, 4.25 g (0.0194 COOH equivalents) of the liquid from Ex 34 and 0.08 g of 2-phenyl-2-imidazoline into a fine powder that has a gel time, at 400° C. of 0.72 minute. DSC analysis of the powder shows Tgs at 13° C. and 30° C. with a melting endotherm at 60° C., followed by an exotherm of 58 joules/g and respective onset and peak temperatures of 101° C. and 167° C. The powder cures to a clear polymer with a first pass DSC Tg of 70° C. and a second pass DSC Tg of 76° C.

### EX 36

Use the apparatus of Ex 33 to convert 7.3 g of the powder from Ex 35, 17.03 g of the 80:20 mix of DOWANOL™ EB:cyclohexanone mixture and 3 drops of the same polysiloxane surface modifier as in Comp Ex A into a shaken coating solution. Use a #46 draw down bar to coat the cold-rolled steel panels and a #26 draw down bar to coat the tin-free steel panels. Cured cold-rolled steel panel coatings have a thickness of 0.62 mil (1.57×10⁻⁵ m), a ⅛ inch Mandrel Bend rating of failure at 8 mm, a Cross Hatch Adhesion rating of no failure, Impact Resistance (Direct/Reverse) ratings in inch pounds of 140/less than 10. The tin-free steel panel coatings have a thickness of 0.389 mil (9.88×10⁻⁶ m) and a Wedge Bend Failure rating of 94 mm.

TABLE 1
Properties of Cured Coatings on Cold-Rolled Steel Panels

| | | | | | Impact | | Methyl |
|---|---|---|---|---|---|---|---|
| | | | | | Resistance | | Ethyl |
| | Catalyst | Coating | ⅛ inch | Cross | (Direct/ | | Ketone |
| Example | Level | Thickness | Mandrel | Hatch | Reverse), | Pencil | Double |
| Number | (phw) | (mils) | Bend | Adhesion | in. lbs. | Hardness | Rubs |
| A | 0.50 | 0.371 | No | No | >160/>160 | 2H | <25 |
| | | | Failure | Failure | | | |
| 2 | 0 | 0.459 | No | No | >160/>160 | H | 25 |
| | | | Failure | Failure | | | |
| 7 | 1.99 | 0.672 | No | No | >160/>160 | HB | 50 |
| | | | Failure | Failure | | | |
| 9 | 0 | 0.368 | No | No | >160/>160 | 3H | 25 |
| | | | Failure | Failure | | | |
| 11 | 0 | 0.866 | No | No | >160/140 | Not | 50 |
| | | | Failure | Failure | | determined | |
| 13 | 0 | 0.416 | No | No | >160/>160 | 4H | 25 |
| | | | Failure | Failure | | | |
| 16 | 2.00 | 0.604 | No | No | >160/>160 | 2H | 25 |
| | | | Failure | Failure | | | |
| 19 | 0 | 0.460 | Not | Not | >160/>160 | 3H | 50 |
| | | | determined | determined | | | |
| 23 | 2.00 | 0.765 | No | No | >160/>160 | 3H | 75 |
| | | | Failure | Failure | | | |
| 25 | 0.38 | 0.941 | 11 mm | 5% | 120/80 | HB | 25 |
| | | | Failure | Failure | | | |
| 29 | 0 | 0.377 | No | No | >160/>160 | 2H | 25 |
| | | | Failure | Failure | | | |

Note:
phw = parts per hundred weight

The data presented in Table 1 show that solvent-applied coatings based upon compositions of the present invention show good to very good flexibility, toughness, adhesion and hardness and, relative to Comp Ex A, improved solvent resistance.

TABLE 2
Properties of Cured Coatings on Tin Free Steel Panels

| Example | Catalyst Level | Coating Thickness, | Wedge Bend Test, |
|---|---|---|---|
| Number | (phw) | mils/μm | mm of Failure |
| A | 0.50 | 0.392/9.96 | 0 |
| 2 | 0 | 0.350/8.89 | 0 |
| 7 | 1.99 | 0.452/11.48 | 0 |
| 9 | 0 | 0.333/8.46 | 67 |
| 11 | 0 | 0.866/22 | 62 |
| 13 | 0 | 0.303/7.7 | 0 |
| 16 | 2.00 | 0.399/10.13 | 0 |
| 19 | 0 | 0.392/9.96 | 17 |
| 23 | 2.00 | 0.475/12.06 | 0 |
| 25 | 0.38 | 0.524/13.31 | 31 |
| 33 | 0 | 0.346/8.79 | 0 |

The data presented in Table 2 demonstrate that solvent applied coatings based upon several compositions representative of the present invention (e.g. Ex 2, Ex 7, Ex 13, Ex 16, Ex 23 and Ex 33) do not fail in the Wedge Bend Test, an indication of excellent adhesion, flexibility and toughness. Although Ex 9, Ex 11, Ex 19 and Ex 25 have higher than desired values for the Wedge Bend Test, they are useful in applications that do not involve bending to the degree experienced in Wedge Bend Testing.

TABLE 3
Properties for Powder Formulations Based on a Carboxylic
Acid Functional Polyester and a Hydroxyalkylamide

| | | Gel Time @ | Glass Transition |
|---|---|---|---|
| Example | Catalyst Level | 204° C. | Temperature of Cured |
| Number | (phw) | (minutes) | Formulation¹ (° C.) |
| A | 0 | 1.25 | 80 |
| 5 | 0 | 1.7 | 73 |
| 6 | 2.0 | 1.0 | 79 |
| 15 | 2.0 | 0.83 | 83 |
| 22 | 2.0 | 0.78 | 84 |
| 31 | 0.5 | 0.72 | 89 |

Note
¹Formulation Cured at 204° C. for 11 minutes.

The data presented in Table 3 demonstrate that cured coatings based upon acid functionalized compositions of the present invention have Tg's similar to that of Comp Ex A which is based upon a carboxylic acid terminated polyester. As such, the acid functionalized compositions of the present invention provide an acceptable alternative to carboxylic acid terminated polyesters. As the acid functionalized compositions of the present invention have shorter gel times, an indication of higher reactivity and more rapid cures relative to a carboxylic acid terminated polyester, compositions of the present invention may be preferred over conventional carboxylic acid terminated polyesters.

The data in Tables 1, 2 and 3 further demonstrate that compositions of the present invention, based upon renewable resources (e.g. seed oils), provide comparable performance to fossil fuel derived materials such as carboxylic acid terminated polyesters. Use of compositions of the present invention therefore present opportunities to reduce costs and dependence on fossil fuel based raw materials.

TABLE 4
Viscosities of Carboxlic Acid Derivatives

| Example Number | Viscosity @ 150° C., cps |
|---|---|
| A & B (URALAC ™ 5271) | >4000 |
| 4 | 600 |
| 8 | 440 |
| 10 | 4500 |
| 12 | 50 |
| 14 | 1000 |
| 18 | 70 |
| 21 | 1100 |
| 24 | 125 |
| 28 | 650 |
| 30 | 2000 |
| 32 | 30 |
| 34 | 150 |

The data presented in Table 4 show that compositions of the present invention have much lower viscosities than a conventional carboxylic acid terminated polyester (Comp Ex A and B). This translates to processing advantages such as improved mixing and substrate wet out.

### EX 37

### Preparation of Hybrid Powder Coating Composition

Place the flask used in Ex 8 above and its remaining contents (after removing material for Ex 9 and Ex 10) into an oven operating at a set point temperature of 60° C. for a period of two hours. Remove the flask from the oven and pour the contents onto a high glass tray (45 centimeters (cm) long by 30 cm wide by 5 cm deep). Allow the contents to cool to ambient temperature (nominally 25° C. and then place it in a dry ice container having a temperature of −109.3° F. (−78.5° C.) for one hour to solidify the contents.

Remove the solidified contents from the glass tray, break the solidified contents into pieces and place 16.4 parts by weight (pbw) of pieces into a high speed mixer (Prism Pilot™, Thermo Electron Corporation). Add 54.21 pbw of the same epoxy resin as used in Comp Ex A, 0.14 pbw of a reaction product of an epoxy resin and an imidazole (EPI-CURE™ P101, Hexioin Specialty Chemicals, Inc.) as a first catalyst, 0.21 pbw of triphenylphosphine (Rhodia Inc.) as a second catalyst, 27.4 pbw of titanium dioxide pigment (Ti-Pure® R-706, E. I. du Pont de Nemours & Company), 1.32 pbw of a blend of an ethyl acrylate/2-ethylhexyl acrylate copolymer and silicon dioxide (MODAFLOW® POWDER III Resin Modifier, Cytec Surface Specialties Inc.) as a flow modifier, and 0.49 pbw of benzoin (Sigma Aldrich) as a degassing agent. Add 20 parts by weight dry ice per 100 parts by weight of mixer contents other than dry ice. Operate the mixer at a speed of 200 revolutions per minute (rpm) for 15 seconds, the allow the contents of the mixture to degas, before gradually increasing mixer speed to 2300 rpm in 15 second increments with intermediate degassing steps to yield a fine powdered admixture.

Use a twin screw compounding extruder (PRISM™ TSE 24PC, Thermo Electron Corporation) equipped with three heating zones, a chill roll, and a belt flaker and chipper to convert the fine powdered admixture to an extrudate. The heating zones and their respective set point temperatures are: feed zone=20° C.; middle zone=70° C.; and heat zone=90° C. The extruder has a screw diameter of 24 mm and a screw speed of 400 rpm.

Break solidified extrudate into pieces or flakes and feed the pieces or flakes into a Hosokawa MIKRO PUL™ ACM-2L grinder (Micron Powder Systems) to yield a ground powder having an average particle size of 46 micrometers (μm), and an average gel time at 204° C. of 51.4 seconds.

Electrostatically spray an aliquot of the ground powder onto two different metal substrates to yield two spray coated substrates. Subject one spray coated substrate to a curing temperature of 130° C. for 20 minutes and the other or second spray coated substrate to a curing temperature of 180° C. for 20 minutes. Subsequent to curing, the first spray coated substrate has a coating thickness of 2.25 mils (5.7×10⁻⁵ meter (m)), a percent adhesion (ASTM D3359) of 5B, and ASTM D523 gloss values of 26.8 at 20°, 76.1 at 60° and 80.3 at 85°. Similarly, the second spray coated substrate has a coating thickness of 3.19 mils (8.1×10⁻⁵ meter (m)), a percent adhesion (ASTM D3359) of 5B, and ASTM D523 gloss values of 7.1 at 20°, 42 at 60° and 63.9 at 85°. Both cured, spray coated substrates have coatings with a matte appearance and yield a Fail rating according to ASTM D522 (conical mandrel). The second cured, spray coated substrate has a coating with a slight yellow tinge. Direct impact testing of both cured, spray coated substrates provides an ASTM D 2794 rating of 20 inch-pounds. MEK Double Rub testing provides a Coating Double Rub Failure Number of less than 10 for the first substrate and 100 for the second substrate. Both coatings have a Pencil Hardness of 3H.

### EX 38-41 AND COMP EX C

Replicate Ex 37 using formulations shown in Table 5 below using the castor oil derivative of Ex 4 for Ex 38 and 40, the soy oil derivative of Ex 21 for Ex 39 and Ex 41, and neither derivative for Comp Ex C. All contain an amount of epoxy resin (DER 663U, The Dow Chemical Company). Comp Ex C and Ex 38 and 39 include an amount of a saturated, carboxylated polyester resin used for epoxy resin cure (URALAC™ 5998, DSM Coating Resins Europe B.B.). Each of Ex 38-41 and Comp Ex C contain 28.1 wt % of the same titanium dioxide powder as in Ex 37, 1.0 wt % of the same flow modifier as in Ex 37, 0.4 wt % of the same degassing agent as in Ex 37 and 0.18 wt % of 2-phenyl-2-imidazoline (Vestagon® B 31, Degussa Corporation). Each of these wt % values as well as those in Table 5 below is based upon total coating composition weight. Curing conditions include a temperature of 200° C. and a time of 20 minutes. Table 5 also summarizes physical property test results of cured coatings.

TABLE 5

| | Ex ID | | | | |
|---|---|---|---|---|---|
| | Comp | | | | |
| | Ex C | Ex 38 | Ex 39 | Ex 40 | Ex 41 |
| Component | | | | | |
| or Test | | | | | |
| Castor Oil | None | 11.9 | None | 18.36 | None |
| Derivative | | | | | |
| Soy Oil | None | None | 12.0 | None | 18.66 |
| Derivative | | | | | |
| Epoxy resin | 36.2 | 46.6 | 46.3 | 51.95 | 51.64 |
| Polyester resin | 34.2 | 11.9 | 12.0 | None | None |
| Physical | | | | | |
| Properties | | | | | |
| Gel Time (sec) | 63.5 | 49.3 | 26.3 | 48 | 18.4 |
| 20° Gloss | 83.4 | 43.1 | 15.9 | 15.6 | 1.9 |
| 60° Gloss | 96.9 | 91.1 | 66.3 | 65.1 | 10.8 |
| Thickness | 2.02/5.1 | 2.02/5.1 | 2.02/5.1 | 2.15/5.5 | 2.77/7.0 |
| (mils/×10⁻⁵ m) | | | | | |
| Impact | 120/120 | 140/140 | 140/160 | 120/120 | 140/60 |
| Direct/Reverse | | | | | |
| (in-lb) | | | | | |
| MEK Double | 85 | 85 | 61 | 200 | 50 |
| Rub Number | | | | | |
| Pencil | 3H | 3H | 3H | 2H | 2H |
| Hardness | | | | | |
| Scratch Test | 53 | 49 | 52 | 66 | 57 |
| Load (N) | | | | | |

The data presented in Table 5 suggest that use of seed oil acid derivatives yields improved scratch resistance relative to scratch resistance provided by a conventional carboxylic acid polyester (Ex 40 and 41 relative to Comp Ex C). The data also suggest that both gel time and gloss reductions occur with use of seed oil acid derivatives in place of part (Ex 38 and 39) or all (Ex 40 and 41) of a conventional carboxylic acid polyester.

1. (canceled)

2. A hydroxyl terminated monomer composition comprising a hydroxyl terminated monomer represented by Formula I. 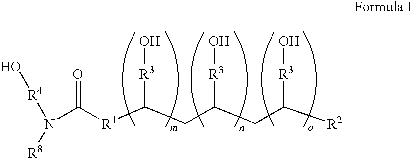
wherein R¹ is a hydrocarbylene moiety; R² is hydrogen or a hydrocarbyl moiety; R³ is nil or a hydrocarbylene moiety; R⁴ is a hydrocarbylene moiety; R⁸ is H, a hydrocarbyl moiety or a moiety represented by Formula II:
—R⁴—OH Formula II
wherein R⁴ is as defined above; and m, n, and o are independently 0 or 1 provided a sum of m, n and o is greater than zero in admixture with an amount of a second hydroxyl terminated monomer represented by Formula I wherein the sum of m, n and o is zero.

3. The hydroxyl terminated monomer composition of claim 2, wherein the amount of the hydroxyl terminated monomer having the sum of m, n and o greater than zero is greater than or equal to seventy percent by weight, based upon total composition weight.

4. The hydroxyl terminated monomer composition of claim 3, wherein the amount is greater than or equal to seventy five percent by weight, based upon total composition weight.

5. A curable composition, the composition comprising the hydroxyl terminated monomer composition of any of claims 2, 3 or 4, a carboxylic acid terminated monomer and, optionally, either or both of a hydroxyalkylamide other than the hydroxyl terminated monomers of claim 2 and a multi-functional epoxy resin.

6. A curable composition, the composition comprising the hydroxyl terminated monomer composition of claim 2, a carboxylic acid terminated monomer and, optionally, either or both of a hydroxyalkylamide other than either hydroxyl terminated monomer of claim 2 and a multi-functional epoxy resin.

7. A reactive monomer composition comprising an amide carboxylic acid represented by Formula III: 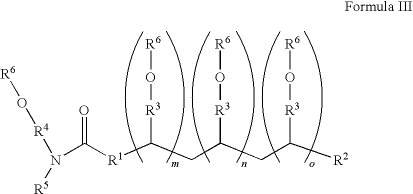
wherein R¹ is a hydrocarbylene moiety; R² is hydrogen or a hydrocarbyl moiety; R³ is nil or a hydrocarbylene moiety; R⁴ is a hydrocarbylene moiety; R⁵ is H, a hydrocarbyl moiety or a moiety represented by Formula IV:
—R⁴—O—R⁶ Formula IV
wherein R⁴ is as defined above and R⁶ is a moiety of Formula V: 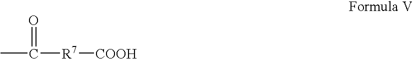
wherein R⁷ is a hydrocarbylene moiety; and m, n, and o are independently 0 or 1 provided a sum of m, n and o is greater than zero.

8. A curable resin composition comprising the reactive monomer composition of claim 7, a multi-functional epoxy resin and, optionally, either or both of a monomer having a terminal carboxylic acid moiety, the monomer being a monomer other than the reactive monomer composition of claim 7, and a curing catalyst.

9-12. (canceled)

13. A coating composition comprising the curable composition of any of claim 5, claim 6 or claim 8.

14. A coating composition comprising the reactive monomer composition of claim 7.
